(19) United States
(12) Patent Application Publication
(10) Pub. No.: US 2023/0336539 A1
(43) Pub. Date: Oct. 19, 2023

(54) TESTS RESULTS WITH SECURE ELEMENTS AND CRYPTOGRAPHY

(71) Applicant: Noodle Technology Inc., San Francisco, CA (US)

(72) Inventors: Micha Anthenor BENOLIEL, San Francisco, CA (US); Lucien LOISEAU, San Francisco, CA (US); Eliott TEISSONNIERE, San Francisco, CA (US); Garrett Kinsman, San Francisco, CA (US)

(21) Appl. No.: 17/997,655

(22) PCT Filed: Apr. 30, 2021
(86) PCT No.: PCT/US2021/030308

§ 371 Date: Oct. 31, 2022

Related U.S. Application Data
(60) Provisional application No. 63/018,481, filed on Apr. 30, 2020.

(51) Int. Cl. H04L 9/40; H04L 9/08

(52) U.S. Cl. CPC H04L 63/0823; H04L 63/0861; H04L 63/0442; H04L 9/0877

(57) ABSTRACT

In one example embodiment, a method may include testing a characteristic associated with a user and generating a signature file indicative of completion of the test of the characteristic associated with the user. The signature file may include results of the test of the characteristic associated with the user and a certificate indicative that the results of the test of the characteristic associated with the user is certified.

### CROSS-REFERENCE TO RELATED APPLICATIONS

This application is a Conversion of U.S. Patent Application No. 63/018,481, filed Apr. 30, 2020, titled TESTS RESULTS WITH SECURE ELEMENTS AND CRYPTOGRAPHY, which is incorporated herein by reference in their entireties.

### BACKGROUND

The present disclosure relates to certifying test results or measurements with secure elements and cryptography.

In some circumstances, it may be desirable for an individual or a user to perform a measurement or test on their own. For example, a user may perform a medical test at home, while traveling, or otherwise without being in a medical facility. However, the results of the test may not be relied upon as accurate without verifying that the test is genuine and properly performed. Accordingly, in many circumstances medical tests are performed under the supervision of medical personnel (e.g., at a medical facility or otherwise) or are administered by medical personnel. However, performing tests in this manner may increase costs, decrease accessibility of testing, and may be inconvenient or impracticable in some circumstances.

The claimed subject matter is not limited to embodiments that solve any disadvantages or that operate only in environments such as those described above. This background is only provided to illustrate examples of where the present disclosure may be utilized.

### SUMMARY

The present disclosure generally relates to certifying test results or measurements with secure elements and cryptography.

In one non-limiting example, a method may include testing a characteristic associated with a user and generating a signature file indicative of completion of the test of the characteristic associated with the user. The signature file may include results of the test of the characteristic associated with the user and a certificate indicative that the results of the test of the characteristic associated with the user is certified.

The method may include monitoring operations for the test of the characteristic associated with the user to verify the test of the characteristic associated with the user is performed correctly.

In some aspects, the signature file may include a proof of execution that establishes that the correct executable code was executed for the test of the characteristic associated with the user.

The characteristic associated with the user may be obtained using a testing device associated with the user. The signature file may include a public key associated with the testing device, wherein the public key is indicative of the identity of the testing device. The signature file may include a certificate generated by a manufacturer of the testing device to establish the authenticity of the testing device. The signature file may include an identifier which links the results of the test of the characteristic and the user. The signature file may include an indication of the time at which the testing device was used to obtain the results of the test of the characteristic associated with the user. In some aspects a cryptographic asymmetric keypair may be used to generate the signature file, and the signature file is cryptographically signed by the testing device.

Testing the characteristic associated with the user may include obtaining a biological sample from the user. Testing the characteristic associated with the user may include performing operations to test the sample. Testing the characteristic associated with the user may be initiated by the user.

In another non-limiting example, a testing device may include a testing chip configured to test a characteristic associated with a user, and a secure element configured to generate a signature file indicative of completion of the test of the characteristic associated with the user. The signature file may include results of the test of the characteristic associated with the user and a certificate indicative that the results of the test of the characteristic associated with the user is certified.

In some aspects, the secure element may include a secure cryptoprocessor to carry out cryptographic operations to certify the results of the test of the characteristic associated with the user. The secure element may include a hardware security module. The secure element may include a tamper-evident containment. The testing device may include at least one physical security measures to protect the secure element or the testing chip from tampering. The secure element may be configured to monitor operations of the testing chip to verify the test of the characteristic associated with the user is performed correctly. The secure element may use a cryptographic asymmetric keypair to generate the signature file, and the signature file may be cryptographically signed.

The signature file may include one or more of: a proof of execution that establishes that the testing chip executed correct executable code for the test of the characteristic associated with the user; a public key associated with the testing device, wherein the public key is indicative of the identity of the testing device; a certificate generated by a manufacturer of the testing device to establish the authenticity of the testing device; an identifier which links the results of the test of the characteristic and the user; and an indication of the time at which the testing device was used to obtain the results of the test of the characteristic associated with the user.

This Summary introduces a selection of concepts in a simplified form that are further described below in the Detailed Description. This Summary is not intended to identify key features or essential characteristics of the claimed subject matter, nor is it intended to be used as an aid in determining the scope of the claimed subject matter.

### BRIEF DESCRIPTION OF THE DRAWINGS

FIG. 1 is a schematic diagram of an example environment relating to certifying test results or measurements with secure elements and cryptography.

FIG. 2 is a schematic diagram of an example of a system for provisioning and authenticating certificates for devices.

FIG. 3 is a flow diagram of an example method to certify test results or measurements with secure elements and cryptography.

FIG. 4 is a diagrammatic representation of a computing device within which a set of instructions, for causing the computing device to perform any one or more of the methods discussed herein, may be executed.

### DETAILED DESCRIPTION

Reference will be made to the drawings and specific language will be used to describe various aspects of the disclosure. Using the drawings and description in this manner should not be construed as limiting its scope. Additional aspects may be apparent in light of the disclosure, including the claims, or may be learned by practice.

The disclosed embodiments relate to certifying test results or measurements with secure elements and cryptography. An individual or a user may wish to perform a measurement or test on their own, for example, a user may perform a medical test at home, while traveling, or otherwise without being at a medical facility. However, the results of the test may not be relied upon as accurate without verifying that the test is genuine and properly performed. Accordingly, in many circumstances medical tests are performed under the supervision of medical personnel (e.g., at a medical facility or otherwise) or are administered by medical personnel. However, performing tests in this manner may increase costs, decrease accessibility of testing, and be inconvenient or impracticable in some circumstances. Thus, the disclosed embodiments permit tests to be authenticated and verified using secure elements and cryptography. This in turn permits the results of the tests to be relied upon by third parties because the tests are authenticated and verified.

For example, during the COVID-19 pandemic, tests to detect the COVID-19 virus were generally performed by medical personnel to verify that the tests were conducted properly, to verify the identity of the person tested, and to properly interpret results. In addition, the supply chain for tests were strictly controlled to verify the authenticity of the tests (to ensure counterfeit tests were not distributed). In some circumstances, in-home or personal tests were available, however, such tests were generally not relied upon by medical personnel and were not sufficient to permit travel or avoid quarantine restrictions, because of the concerns described above.

The disclosed embodiments implement secure elements and cryptography to certify tests and associated test results to ensure that test results are authentic and properly performed.

In the context of COVID-19 testing, the disclosed embodiments may provide cryptographic proof of a negative COVID-19 test result from an authentic test that was performed properly by the user. Additionally or alternatively, the disclosed embodiments may be used to generate a digital authorization for the user to end quarantine, to be able to travel, to avoid COVID-19 related restrictions, or otherwise.

However, the disclosed embodiments are not limited to COVID-19 testing. Rather, any suitable medical tests may be certified according to the disclosed embodiments. Furthermore, the disclosed embodiments are not limited to medical testing. In fact, the disclosed embodiments may be implemented with any suitable test to certify the test and results. For example, the disclosed embodiments may be implemented with Geiger counters, weather measurements, safety devices (e.g., in vehicles or otherwise), etc.

According to the disclosed embodiments, a testing device may include a secure element such as a secure cryptoprocessor to carry out cryptographic operations, such as certifying the test results performed at the testing device. The secure element may be configured to provide an indication that the test associated with the testing device was used correctly. Additionally or alternatively, the secure element may be configured to provide an indication of the test result. For example, the secure element may be configured to provide an indication of a negative result (e.g., an individual is not infected) or a positive result.

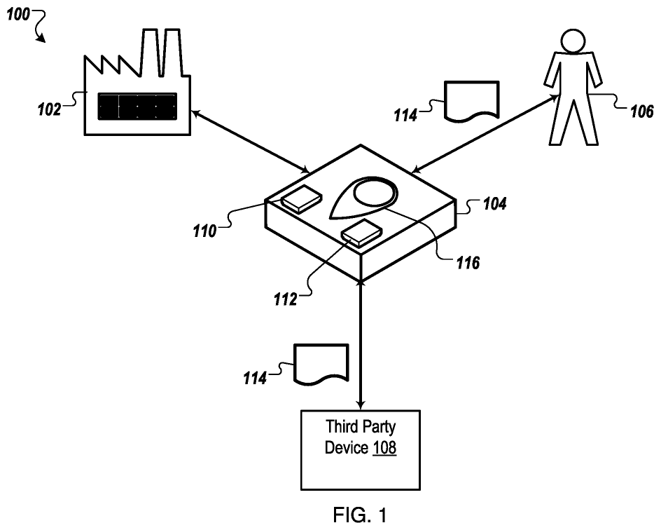

FIG. 1 illustrates an example environment 100 in which embodiments of the present disclosure may be implemented. The environment 100 may include a manufacturer 102 that produces one or more testing devices 104, for example, for one or more users 106. The testing device 104 may include a test to measure or identify a characteristic. For example, in some circumstances the characteristic may be associated with the user 106. If the testing device 104 is associated with a medical test, the testing device 104 may determine if the user is infected with a pathogen that may cause a disease, such as a bacteria or virus. Additionally or alternatively, the testing device 104 may measure a biological characteristic or health indicator of the user, such as blood pressure, glucose level, heart rate, temperature or other suitable biological indicator.

In other circumstances, the testing device 104 may not measure characteristics that are associated with the user 106. In particular, the testing device 104 may test characteristics of the environment, which may or may not surround the user. For example, the testing device 104 may include a Geiger counter for measuring ionizing radiation in the environment surrounding the user 106. In other configurations, the testing device 104 may measure the environment remote of the user 106. For example, the testing device 104 may be positioned remote of the user 106 and may measure weather characteristics of the environment, such as temperature, wind speed, barometric pressure, etc. In yet another example, the testing device 104 may measure characteristics associated with a vehicle that the user 106 is driving, such as speed, braking power, seatbelt usage, airbag deployment etc.

The above examples illustrate that the testing device 104 may be configured to test a variety of characteristics, and the disclosed embodiments include testing and/or measurement of any suitable characteristics or measurements.

The testing device 104 may include a testing chip 112 (e.g., microchip and/or integrated circuit) that is configured to execute the test, for example, either automatically or when instructed by the user 106. The testing chip 112 may be configured to perform operations and/or execute logic to test a sample or to gather measurements and/or test data. In some configurations, the testing chip 112 may be communicatively coupled to one or more sensors 116 configured to test the sample and/or gather measurements. The testing chip 112 may receive data from the sensor 116 regarding the sample and may process the data to obtain test results.

The testing device 104 may include a secure element 110. In some configurations, the secure element 110 may include a secure cryptoprocessor to carry out cryptographic operations, such as certifying the test results performed at the testing device. Additionally or alternatively, the secure element 110 may include a hardware security module (HSM). As shown, the secure element 110 may be separate from the testing chip 112. In such configurations, the secure element 110 may be communicatively coupled to the testing chip to monitor the operations on the testing chip 112 to authenticate results and/or to verify the test was performed correctly. In other configurations, the secure element 110 may be included in the testing chip 112 itself. Furthermore, any suitable modifications or variations may be implemented according to the concepts described.

The testing device 104 and/or the secure element 110 may include packaging with one or multiple physical security measures, which provide protection from tampering. For example, the secure element 110 may not reveal keys or executable instructions on a bus, except in encrypted form, and zeros keys in response to attempts at probing or scanning. The secure element 110 may be potted in with other processors and memory chips that store and process encrypted data. Any attempt to remove the potting may cause the keys in the secure element 110 be zeroed. The secure element 110 may also be part of the testing chip that operates inside a locked compartment to deter theft, substitution, and/or tampering. In some configurations, the testing device 104 and/or the secure element 110 may include tamper-detecting and tamper-evident containment, conductive shield layers that prevent reading of internal signals, controlled execution to prevent timing delays from revealing any secret information, automatic zeroization of secrets in the event of tampering, a chain of trust boot-loader which may authenticate the operating system before loading it, a chain of trust operating system which authenticates application software before loading it, hardware-based capability registers implementing a one-way privilege separation model, and/or any other suitable security measures, or combinations thereof.

The testing device 104 may be include a cryptographic asymmetric keypair. In some configurations, the cryptographic asymmetric keypair may be included, for example, on the secure element 110. The cryptographic asymmetric keypair may identify the testing device 104, and may be unique for every testing device produced by the manufacturer 102 and/or every testing device in existence. In some circumstances, the cryptographic asymmetric keypair may be included in an NFC chip or Bluetooth sticker, which may be included on a housing or container of the testing device 104 that contains the secure element 110. The executable code and/or the cryptographic asymmetric keypair associated with the testing device 104 may be signed by a certification authority to ensure its authenticity. In some configurations, the certification authority may be the manufacturer 102, although other configurations may be implemented. Accordingly, the manufacturer 102 may generate a certificate to establish the authenticity of the testing device 104. The certificate may be included, for example, on the secure element 110.

Aspects of provisioning and authenticating device certificates are described in further detail in PCT Application no. PCT/US2020/051127 filed Sep. 16, 2020 entitled Provisioning and Authenticating Device Certificates, which is hereby incorporated by reference in its entirety.

The testing device 104 may be provided to the user 106 for the user 106 to perform the test. For example, the testing device 104 may be shipped to the user 106. Once received, the user 106 may initiate the test via the testing device 104. For example, the user 106 may provide an input to initiate the test. In some configurations, the user 106 may input a sample or other suitable input to the testing device 104. For example, the user 106 may input a saliva, blood, tissue or other suitable biological sample into the testing device 104, for example, using the sensor 116. In other configurations, the user 106 may press a button or other suitable input to initiate the test.

After the testing device 104 performs the test, the testing device 104 may generate a signature file 114 indicative of the completed test. The signature file 114 may include a proof of execution that establishes that the correct firmware and/or executable code was executed using the testing device 104 (e.g., on the secure element 110). The signature file may include a public key associated with the testing device 104. The public key may be indicative of, for example, the identity of the testing device 104. Accordingly, the public key may identify the testing device 104, and may be unique for every testing device produced by the manufacturer 102 and/or every testing device in existence. The signature file 114 may include the certificate generated by the manufacturer 102 to establish the authenticity of the testing device 104. Thus, the certificate may be indicative that the results of the test from the testing device 104 is certified.

The signature file 114 may include an output from the testing device 104, which may include the results and/or data of the test from the testing device 104. In some configurations, the output may be binary, such as “positive” or “negative.” For example, the output may indicate whether the sample provided to the testing device 104 included a certain pathogen (such as the virus or bacteria that causes a certain disease). In other configurations, the output may include a numerical value indicative of a biological characteristic, such as blood pressure, glucose level, heart rate, temperature or other suitable biological indicator. In further configurations, the output may be indicative of any suitable characteristic tested by the testing device 104, which may include more detailed data or datasets.

The signature file 114 may include an indication of the identity of the user 106. In some configurations, the identify of the user 106 may be masked in the signature file 114. For example, the identity of the user 106 may be represented by a public key or a similar identifier which may link the output of the testing device 104 with the user 106, without revealing the identity of the user 106.

The signature file 114 may include an indication of the date and time at which the testing device 104 was used, and/or an indication of the date and time that the test results were obtained. In some configurations, the testing device 104 may be configured to be used by the user 106 repeatedly or regularly (e.g., every few days, weeks etc.). In such configurations, the signature file 114 may include test results from multiple tests and the associated date and time. Additionally or alternatively, the signature file 114 may include encrypted data associated with the user 106 and/or the testing device 104.

The testing device 104 may use its cryptographic asymmetric keypair to generate the signature file 114, and the signature file 114 may be cryptographically signed by the testing device 104.

Once the test is completed and process by the testing device 104, the signature file 114 may be shared and/or provided to the user 106. The signature file 114 may be provided to the user 106 in any suitable manner, such as via a mobile device, QR code, physical or electronic output, etc. Additionally or alternatively, the signature file 114 may be stored, for example, in a database or in a digital wallet associated with the user 106.

Additionally or alternatively, the signature file 114 may be provided and/or stored in a health monitoring application (e.g., through an app on a mobile device of the user 106). The signature file 114, or a portion or summary thereof, may be provided to a third-party device 108. For example, the signature file 114, or a portion thereof, may be provided to the third-party device 108 to prove a negative infection status. Such aspects will be described in further detail below. Additionally or alternatively, the signature file 114, or a portion thereof, may be published onto a shared database such as a blockchain, Directed Acyclic Graph, public database etc.

In some configurations, the signature file 114 and/or the certificate may be generated by the testing device 104 only in circumstances when a test result is positive (not when it is negative) in order to preserve privacy. In such configurations, the absence of the signature file 114 and/or the certificate may indicate either that the testing device 104 was not used, that the test was not performed, or that the test result was positive (e.g., the user 106 is infected with the test pathogen).

In some configurations, the user 106 may share the signature file 114, or a portion or summary thereof, with others to establish a specific test result. For example, the user 106 may share the signature file 114 to establish a negative test result for a specific pathogen, or to establish that the user 106 does not have an elevated temperature, etc.

As mentioned above, the signature file 114, or a portion or summary thereof, may be provided to a third-party device 108. The signature file 114 may be verified by the third-party device 108 based on the contents of the signature file 114. The signature file 114 may be presented to or shared with the third-party device 108.

The third-party device 108 may verify the date and time that the test results were obtained, based on the signature file 114. In some configurations, the third-party device 108 may verify that the date and time is within a pre-defined time frame. For example, the pre-defined time frame may be within 72 hours of travel, and the third-party device 108 may verify that the date and time is within that pre-defined time frame.

Further, the third-party device 108 may verify the proof of execution of the signature file to ensure that the correct test was performed. Additionally or alternatively, the third-party device 108 may verify the proof of execution of the signature file 114 to verify that the correct operations and/or logic were executed in order to test the sample or to gather measurements and/or test data. The third-party device 108 may verify any suitable aspects of the signature file 114 in order to certify that the test results obtained by the user 106 using the testing device 104. Once the test results are verified, the third-party device 108 may generate proof that the test results are certified.

The third-party device 108 may verify the public key and/or certificate of the signature file in order to verify that the test results comes from a verified and/or reliable source. The third-party device 108 may verify the output (e.g., result) of the test of the signature file 114. In some aspects, the third-party device 108 may only provide access to the user 106 to specific locations only if the signature file 114 includes the requisite output and/or the test results are verified. The third-party device 108 may verify the identity of the user 106 based on the signature file 114. The third-party device 108 may verify that the user 106 is the individual linked to the certificate in the signature file 114. In some aspects, this may include initiating a cryptographic challenge in configurations where the identity of the user is represented as a cryptographic keypair.

In further aspects, the third-party device 108 may perform an action in response to verifying the contents of the signature file 114, for example, as described above. For example, the third-party device 108 may grant access to the user 106 to a specific location or otherwise provide authorization for access in response to verified contents of the signature file 114. Further, any suitable action may be implemented in response to verified contents of the signature file 114.

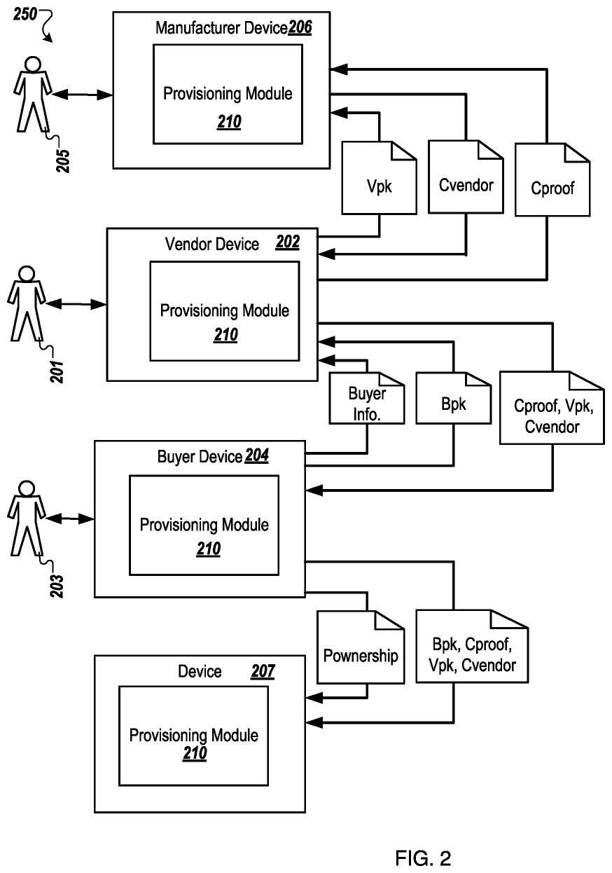

FIG. 2 depicts an example system 200 in which one or more embodiments of the present disclosure may be implemented. With attention to FIG. 2, cryptographic provisioning and certification of devices will be described in further detail. Such aspects may be implemented to provision and certify any suitable devices, such as the testing device 104 described above.

The system 200 may include a vendor 201 that is associated with a vendor device 202, a buyer 203 that is associated with a buyer device 204, and a manufacturer 205 that is associated with a manufacturer device 206. The buyer device 204, the vendor device 202, and the manufacturer device 206 may be communicatively coupled. The buyer device 204, the vendor device 202, and the manufacturer device 206 may be communicatively coupled via a network.

As used in the present disclosure, the term “associated with” when used to describe a relationship between one of the devices (202, 204, and 206) and one of the entities (the vendor 201, the buyer 203, and the manufacturer 205), indicates that the entity has control over or is responsible for the use and operation of the device. Accordingly, in the present disclosure reference may be made to the entity performing an operation. It may be understood that the entity itself may perform the operation or the entity may utilize the associated device to perform the operation. For instance, a description of the buyer performing an operation may indicate that the buyer 203 is performing the action himself and/or the buyer 203 is directing the buyer device 204, causing the buyer device 204, or otherwise implementing the buyer device 204 to perform the action. The system 200 may also include a device 207. The devices 202, 204, and 206 may be implemented in the system to cryptographic provision and certify the device 207.

In some aspects, the device 207 may correspond to the testing device 104 described with respect to FIG. 1. The manufacturer 205 and the manufacturer device 206 may correspond to the manufacturer 102. The vendor 201 and the vendor device 202 may correspond to a vendor of the device 207 (e.g., a vendor of the testing device 104). The buyer 203 and the buyer device 204 may correspond to the user 106 (e.g., a buyer of the testing device 104).

In some embodiments, the devices 202, 204, 206 may cryptographically provision and certify the device 207 prior to device startup. Cryptographically provisioning and certifying the device 207 may reduce or prevent theft of the device 207. For example, without the cryptographic provisioning and certification of the device 207 an unauthorized buyer may not start the device 207. Accordingly, a thief may be disincentivized from stealing the device 207.

Additionally, in some embodiments, the devices 202, 204, 206 may cryptographically provision and certify the device 207 to ensure the buyer 203 meets a particular condition or status. For example, the cryptographical provisioning and certification process may involve the buyer 203 providing some information, which is verified by the vendor 201. Some example of the condition or the status may be an age, a qualification, a medical condition, and the like. The verification of the condition by the vendor 201 may ensure that the device 207 is only being used by an appropriate person.

Additionally, the devices 202, 204, 206 may cryptographically provision and certify the device 207 when connecting the device 207 to another device (e.g., during pairing or during a provisioning data flow). The cryptographic provisioning and certification of the device may facilitate a pairing process and may reduce or prevent counterfeit devices from connecting the genuine accessories. For instance, in these and other embodiments, the buyer 203 may be known, which may enable the devices 202, 204, and 206 to verify that the device 207 is being used in an anticipated way by known buyer with expected/appropriate devices.

In FIG. 2, an example cryptographic provisioning and certification process 250 (hereinafter, “process 250”) is depicted. It may be appreciated with the benefit of this disclosure that one or more of the operations may be performed by another entity 201, 203, and 205 and/or by another of the devices 202, 204, and 206.

One or more of the devices 202, 204, 206, and 207 may include a provisioning module 210, which is shown in each of the devices 202, 204, 206, 207. The provisioning module 210 may be implemented using hardware including a processor, a microprocessor (e.g., to perform or control performance of one or more operations), a field-programmable gate array (FPGA), or an application-specific integrated circuit (ASIC). In some other instances, the provisioning module 210 may be implemented using a combination of hardware and software. Implementation in software may include rapid activation and deactivation of one or more transistors or transistor elements such as may be included in hardware of a computing system (e.g., the devices 202, 204, 206, and 207). Additionally, software defined instructions may operate on information within transistor elements. Implementation of software instructions may at least temporarily reconfigure electronic pathways and transform computing hardware.

The provisioning module 210 may be configured to performed one or more steps of the process 250. In general, the process 250 uses public/private key pairs that are assigned to one or more of the entities 201, 203, and 205. The public/private key pairs may be generated according to one or more PKI policies. The public/private key pairs may enable secured communication between the devices 202, 204, 206, and 207 as well as verification of an origin of a data communicated between the devices 202, 204, 206, and 207. In addition, the process 250 may implement a hash algorithm. For instance, the hash algorithm may be applied to one of the keys of the public/private key pairs. Any suitable hash algorithm may be implemented, however, an example of the hash algorithm may include SHA-512.

For instance, in some embodiments, the vendor 201 may be enrolled by the manufacturer or the manufacturer device 206. Generally, the manufacturer 205 may have constructed, built, and/or sold the device 207. The enrollment of the vendor 201 may be performed using a vendor public key of a public/private key pair assigned to the vendor 201. Additionally, the enrollment of the vendor 201 may be formalized with a cryptographically signed vendor certificate. The cryptographically signed vendor certificate may be configured to prove the vendor 201 is authorized to verify a condition of an device function.

Referring to the examples above, the condition of the device function may include verification of an authorized sale (the condition) of the device 207 prior to the device startup (the device function). Alternatively, the condition of the device function may include verification of an age of the buyer 203 (the condition) prior to enabling the device 207 to perform a function that is limited to mature audiences (the device function). Other conditions and device functions may be verified by the vendor 201. For instance, the device function may include device startup (e.g., following a sale) or connecting the device with another device or system, and the like. The condition may include a buyer identity, a receipt, an age or characteristic of a buyer, and the like.

In some embodiments, the enrolling the vendor 201 may be performed prior to a transaction involving the device 207 and/or the starting the device 207. For example, the vendor 201 may be enrolled prior to the vendor 201 being authorized to sell or otherwise transfer the device 207 to the buyer 203.

The enrolling may also include transmitting to the manufacturer 205 the vendor public key by the vendor 201. In FIG. 2, the vendor public key is represented by Vpk. In response, the manufacturer 205 may communicate to the vendor 201 a signed vendor certificate. The signed vendor certificate is represented in FIG. 2 by Cvendor. In some embodiments, the signed vendor certificate is represented by an example signed vendor certificate expression:

Cvendor=Msk(Hash(Vpk)).

In the signed vendor certificate expression, C_vendor may represent the signed vendor certificate. Additionally, Msk may represent a manufacturer secret key, Hash( ) may represent a hash algorithm; and Vpk may represent a vendor public key. In the signed vendor certificate expression, the manufacturer uses its secret key to sign a hash of the vendor public key.

In some aspects, the device function may be enabled. The device function may be enabled following a transaction involving the device 207. In some embodiments, the transaction may include a purchase of the device 207 such as an authorized purchase of the device 207 from the vendor 201. In other embodiments, the transaction may include another sale (e.g., a secondhand sale), enabling use of the device 207 by another entity, implementing the device 207 with a new system, rebooting the device 207, updating the device 207, or another suitable transaction.

The enablement of the device function may be based on a buyer public key of a public/private key pair assigned to the buyer 203. The buyer public key may be used with the vendor public key to generate a cryptographically signed vendor proof. For instance, in some embodiments, enabling the device function may include receiving, from the buyer 203, particular authenticating information. In FIG. 2, the authenticating information is represented by ‘buyer info.’ The authenticating information is used to substantiate the condition that is needed to be verified prior to enabling the device function. For instance, the authenticating information may include one or more or a combination of a document that verifies an age of the buyer, an identification card, and a proof of purchase.

The vendor 201 or the provisioning module 210 may then verifying the particular authenticating information of the buyer 203 that is received from the buyer 203. The vendor may then receive the buyer public key from the buyer 203. The buyer public key is represented by Bpk in FIG. 2. The provisioning module 210 of the vendor device 202 may generate the cryptographically signed vendor proof. The cryptographically signed vendor proof may be indicative of a verification of the particular authenticating information.

In some embodiments, the cryptographically signed vendor proof may be represented by an example cryptographically signed vendor proof expression:

Cproof=Vsk(Hash(B_pk)).

In the cryptographically signed vendor proof expression, Cproof may represent the cryptographically signed vendor proof. Additionally, Vsk may represent a secret key of a vendor, Hash( ) may represent a hash algorithm, and Bpk may represent a buyer public key. Accordingly, the cryptographically signed vendor proof may be generated by the signing a hash of the buyer public key with a vendor secret key.

The vendor 201 may then provide the cryptographically signed vendor proof as well as the signed vendor certificate and the vendor public key to the buyer. In FIG. 2, the cryptographically signed vendor proof is represented by Cproof, the signed vendor certificate is represented by Cvendor, and the vendor public key is represented by Vpk. In some embodiments, the cryptographically signed vendor proof may be shared with the manufacturer 205. The manufacturer 205 may use the cryptographically signed vendor proof for statistical or business reasons, for instance.

The device function may then be initiated. Initiation of the device function may be based on a buyer proof (in FIG. 2, Pownership) and a communication of the buyer proof to the device 207. In some embodiments, the buyer 203 may also communicate to the device 207 one or more of a vendor public key, the buyer public key, the signed vendor certificate, the cryptographically signed vendor proof. In FIG. 2, the vendor public key is represented by Vpk, the buyer public key is represented by Bpk, the signed vendor certificate is represented by Cvendor, and the cryptographically signed vendor proof is represented by Cproof. In some embodiments, the initiating the device function may include creating, by the buyer 203, the buyer proof. Creation of the buyer proof may include signing a hash of the cryptographically signed vendor proof of the vendor 201. For instance, in these and other embodiments, the buyer proof may be represented by the buyer proof expression:

Pownership=(Bsk Hash(Cproof)).

In the buyer proof expression, Pownership represents the buyer proof. Additionally, Bsk represents a secret key of a buyer, Hash( ) represents a hash algorithm, and Cproof represents a cryptographically signed vendor proof. Accordingly, in the buyer proof, the buyer is signing a hash of the cryptographically signed vendor proof with his secret key. The provisioning module 210 may verify one or more certificates that are communicated between the devices 202, 204, 206, and 207. For example, in some embodiments, the provisioning module 210 of the device may verify the certificates. In some embodiments, the provisioning module 210 may verify that a vendor public key is authorized by a signed vendor certificate to sign the cryptographically signed vendor proof. Additionally or alternatively, the provisioning module 210 may verify that buyer public key (Bpk) is authorized by a cryptographically signed vendor proof to perform the device function of the device 207. Additionally or alternatively, the provisioning module 210 may verify that a signed vendor certificate is signed by a manufacturer secret key (Msk). Additionally or alternatively, the provisioning module 210 may verify that a cryptographically signed vendor proof is signed by a vendor public key (Vpk). Additionally or alternatively, the provisioning module 210 may verify that a buyer proof is signed by a buyer public key (Bpk).

In some embodiments, the manufacturer secret key (Msk) may be included or otherwise installed on the device 207. Accordingly, in these and other embodiments, the manufacturer secret key may not need to be communicated to the device 207.

The provisioning module 210 may then modify a state or a condition such as a technical state of the device 207. In some embodiments, the provisioning module 210 on the device may modify the technical state. In other embodiments, the buyer device 204 or another remote device may communicate a message that modifies the technical state of the device 207. The technical state may be modified based on the verification of the certificates. Modification of the technical state of the device 207 may result in a modification of the device 207 such that the device function that is previously disabled becoming performable. For instance, prior to the modification in state, the device 207 may not be able to be booted up. Following the modification in state, the device 207 may be booted up or started.

Implementation of the process 250 may enable the device to function without the device being communicatively coupled to a centralized server or a WAN, for instance. Indeed, implementation of the process 250 may be performed with the device 207 isolated from a network connecting the other devices 202, 204, and 206. Accordingly, the process 250 provides a technical improvement to previous methodologies in which the device 207 is required to be connected to a centralized network or otherwise being in communicate with a server (e.g., a cloud network). In addition, the process 250 may provide a strict certification process in which the manufacturer 205 can control the vendors 201 authorized to sell and authorize the device 207. The process 250 may accordingly improve security of the device 207 and may reduce the unauthorized use and implementation of fraudulent devices.

In some aspects, a blockchain public key infrastructure (PKI) may be implemented to provision and authenticate device certificates. A public key infrastructure (PKI) may include a set of roles, policies, hardware, software and procedures needed to create, manage, distribute, use, store and revoke digital certificates and manage public-key encryption. The PKI may include a set of roles, policies, hardware, software and procedures needed to create, manage, distribute, use, store and revoke digital certificates and manage public-key encryption. The PKI may be used to provision and authenticate certificates for any suitable devices, such as the testing device 104 of FIG. 1. In other aspects, the PKI may be used to provision and authenticate certificates for websites or any suitable authentication schemes.

The PKI may include a whitelisting authority, a PKI smart contract, and one or more devices, such as the testing device 104. The PKI may be used by one or more manufacturers that want to authenticate (e.g., certify) the identity of their devices. In particular, the manufacturers (e.g., the manufacturer 102 and/or manufacturer 205) may authenticate the identity of the devices they manufacture. Users may use the PKI to verify a certificate of the devices for authentication.

The whitelisting authority may determine or set a list of manufacturers and/or devices that are to be whitelisted or permitted to be identified and authenticated. In other configurations, the whitelisting authority may be a decentralized decision scheme for determining a whitelist, including determining a list of devices that are to be whitelisted, or permitted to be identified and authenticated.

The devices (e.g., the testing device 104 and/or the device 207) may have a cryptographic identity which may be certified by their manufacturer. In one example, the cryptographic identity may be device.manufacturer.iot. The manufacturer may have a manufacturer identity. The manufacture identity may be an umbrella or characterization for all devices manufactured by this specific manufacturer. In one example, the cryptographic identity may be manufacturer.iot.

The whitelisting authority may verify and/or authenticate the applications of the manufacturer, for example, to prevent an undesired third party from getting a certificate. In some configurations, the whitelisting authority may implement a Know Your Customer (KYC) process to identify and verify the identity of its customers, in this case, the manufacturer. The KYC process may include steps taken by the whitelisting authority to establish and/or verify the identity of the manufacturer.

The issued certificates may only allow the manufacturer to sign an identity whose scope is limited to that specific manufacturer. For example, the manufacturer may only be permitted to sign an identity of *.manufacturer.iot, wherein * is a placeholder for an identity of a device which is manufactured by the manufacturer (or any device manufactured by the specific manufacturer). Accordingly, the issued certificates may only allow the manufacturer to sign an identity for devices that were manufactured by the manufacturer. In at least one embodiment, the certificate may be stored on a Hardware Security Module (HSM). A HSM may include a physical computing device that safeguards and manages digital keys, performs encryption and decryption functions for digital signatures, strong authentication and other cryptographic functions.

The PKI smart contract may be a database or storage medium that includes the whitelist determined by the whitelisting authority. In some configurations, the PKI smart contract may be a public registry. The whitelisting authority or network operator may be able to add or ban manufacturers in the PKI smart contract. The manufacturer may be able to add or revoke public signing keys in the PKI smart contract. Furthermore, the manufacturer may be able to revoke a device's keys for specific devices if needed, for example, in case the device is hacked or compromised. In addition, the manufacturer may be able to associate an expiration date with their public keys. In such circumstances, the public keys may be automatically revoked after the expiration date.

Authenticating devices may include the whitelisting authority generating a whitelist. The whitelisting authority may determine or set a list of manufacturers and/or devices that are to be included in the whitelist. The whitelist may be added to the PKI smart contract. In some configurations, the whitelist may be transmitted to the PKI smart contract by the whitelisting authority, which may be communicatively coupled to one another.

The manufacturer may add one or more signing keys to the PKI smart contract. In some configurations, the signing keys may be transmitted to the PKI smart contract by the manufacturer, which may be communicatively coupled to one another. In some circumstances, adding one or more signing keys to the PKI smart contract may include paying a fee to the whitelisting authority and/or network operator.

The manufacturer may provision the device with a keypair and/or a certificate. In some configurations, the keypair and/or a certificate may be transmitted to the device by the manufacturer, which may be communicatively coupled to one another. In other configurations, the keypair and/or a certificate may be included with the device when the device is manufactured by the manufacturer.

The user may send a challenge to the device. In some configurations, the challenge may be transmitted to the device by the user, which may be communicatively coupled to one another. Upon receiving the challenge, the device may reply to the user. The reply may include a challenge signature and/or certificate. In some configurations, the reply may be transmitted to the user by the device. The user may verify certificate and revocation status with the PM smart contract. In some configurations, the certificate verification and revocation status may be transmitted between the user and the PKI smart contract, which may be communicatively coupled to one another.

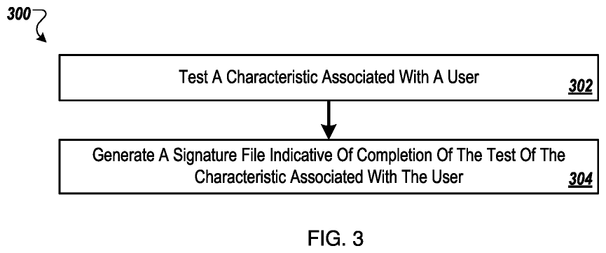

FIG. 3 illustrates a flow diagram of an example method 300 to certify test results or measurements with secure elements and cryptography. For example, the example method may be performed by the testing device 104 of FIG. 1.

The method 300 may begin at block 302, wherein a characteristic associated with a user may be tested. At block 304, a signature file indicative of completion of the test of the characteristic associated with the user may be generated. The signature file may include results of the test of the characteristic associated with the user and a certificate indicative that the results of the test of the characteristic associated with the user is certified.

The method 300 may include monitoring operations for the test of the characteristic associated with the user to verify the test of the characteristic associated with the user is performed correctly.

In some aspects, the signature file may include a proof of execution that establishes that the correct executable code was executed for the test of the characteristic associated with the user.

The characteristic associated with the user may be obtained using a testing device associated with the user. The signature file may include a public key associated with the testing device, wherein the public key is indicative of the identity of the testing device. The signature file may include a certificate generated by a manufacturer of the testing device to establish the authenticity of the testing device. The signature file may include an identifier which links the results of the test of the characteristic and the user. The signature file may include an indication of the time at which the testing device was used to obtain the results of the test of the characteristic associated with the user. In some aspects a cryptographic asymmetric keypair may be used to generate the signature file, and the signature file is cryptographically signed by the testing device.

Testing the characteristic associated with the user may include obtaining a biological sample from the user. Testing the characteristic associated with the user may include performing operations to test the sample. Testing the characteristic associated with the user may be initiated by the user.

In some aspects, the method 300 may be performed by a testing device, such as the testing device 104. As explained above, the testing device 104 may include the testing chip 112 configured to test a characteristic associated with the user 106, and a secure element 110 configured to generate the signature file 114 indicative of completion of the test of the characteristic associated with the user 106. The signature file 114 may include results of the test of the characteristic associated with the user 106 and a certificate indicative that the results of the test of the characteristic associated with the user 106 is certified.

In some aspects, the secure element 110 may include a secure cryptoprocessor to carry out cryptographic operations to certify the results of the test of the characteristic associated with the user 106. The secure element 110 may include a hardware security module. The secure element 110 may include a tamper-evident containment. The testing device 104 may include at least one physical security measures to protect the secure element 110 or the testing chip 104 from tampering. The secure element 110 may be configured to monitor operations of the testing chip 112 to verify the test of the characteristic associated with the user 106 is performed correctly. The secure element 110 may use a cryptographic asymmetric keypair to generate the signature file 114, and the signature file 114 may be cryptographically signed.

The signature file 114 may include one or more of: a proof of execution that establishes that the testing chip 112 executed correct executable code for the test of the characteristic associated with the user 106; a public key associated with the testing device 104, wherein the public key is indicative of the identity of the testing device 104; a certificate generated by a manufacturer 102 of the testing device 104 to establish the authenticity of the testing device 104; an identifier which links the results of the test of the characteristic and the user 106; and an indication of the time at which the testing device 104 was used to obtain the results of the test of the characteristic associated with the user 106.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

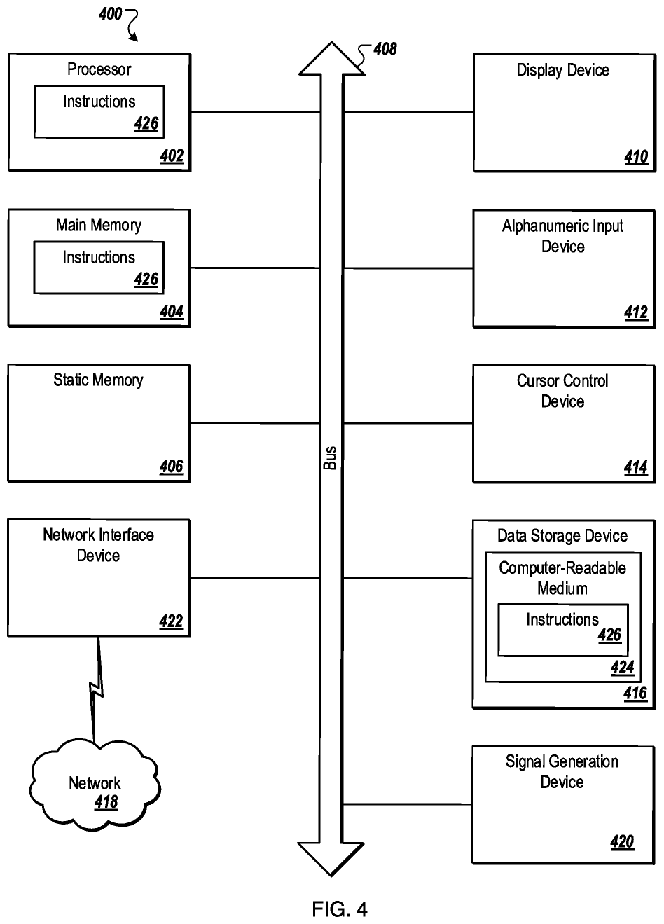

FIG. 4 illustrates a diagrammatic representation of a machine in the example form of a computing device 400 within which a set of instructions, for causing the machine to perform any one or more of the methods discussed herein, may be executed. The computing device 400 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 400 includes a processing device (e.g., a processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

Processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein.

The computing device 400 may further include a network interface device 422 which may communicate with a network 418. The computing device 400 may also include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In at least one embodiment, the display device 410, the alphanumeric input device 412, and the cursor control device may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over a network 418 via the network interface device 422. While the computer-readable storage medium 426 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

The methods described herein may be programmably performed in some embodiments by the manufacturer 102, the testing device 104 and/or the third-party device 108 described with reference to FIG. 1 and/or one of the devices 202, 204, 206, and 207 described with reference to FIG. 2 or some component thereof (e.g., the provisioning module 210). In some embodiments, a computing device (e.g., the device 400 of FIG. 4) may include or may be communicatively coupled to a non-transitory computer-readable medium (e.g., the memory 404 of FIG. 4) having stored thereon programming code or instructions (426) that are executable by a processor (such as the processor 402 of FIG. 4) to cause a computing device to perform the methods 300. Additionally or alternatively, the testing device 104 and/or devices 202, 204, 206, or 207 may include the processor 402 described above that is configured to execute computer instructions to cause a computing device to perform the method 300.

Terms used herein and especially in the appended claims (e.g., bodies of the appended claims) are generally intended as “open” terms (e.g., the term “including” may be interpreted as “including, but not limited to,” the term “having” may be interpreted as “having at least,” the term “includes” may be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” may be interpreted to mean “at least one” or “one or more”); the same holds true for the use of definite articles used to introduce claim recitations.

In addition, even if a specific number of an introduced claim recitation is explicitly recited, those skilled in the art will recognize that such recitation may be interpreted to mean at least the recited number (e.g., the bare recitation of “two recitations,” without other modifiers, means at least two recitations, or two or more recitations). Further, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, may be understood to contemplate the possibilities of including one of the terms, either of the terms, or both terms. For example, the phrase “A or B” may be understood to include the possibilities of “A” or “B” or “A and B.” Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

For the processes and/or methods disclosed, the functions performed in the processes and methods may be implemented in differing order as may be indicated by context. Furthermore, the outlined steps and operations are only provided as examples, and some of the steps and operations may be optional, combined into fewer steps and operations, or expanded into additional steps and operations.

This disclosure may sometimes illustrate different components contained within, or connected with, different other components. Such depicted architectures are merely exemplary, and many other architectures can be implemented which achieve the same or similar functionality.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

What is claimed is:

1. A method, comprising:
testing a characteristic associated with a user; and
generating a signature file indicative of completion of the test of the characteristic associated with the user, wherein the signature file includes results of the test of the characteristic associated with the user and a certificate indicative that the results of the test of the characteristic associated with the user is certified.

2. The method of claim 1, further comprising monitoring operations for the test of the characteristic associated with the user to verify the test of the characteristic associated with the user is performed correctly.

3. The method of claim 1, the signature file comprising a proof of execution that establishes that correct executable code was executed for the test of the characteristic associated with the user.

4. The method of claim 1, wherein the characteristic associated with the user is obtained using a testing device associated with the user.

5. The method of claim 4, the signature file comprising a public key associated with the testing device, wherein the public key is indicative of the identity of the testing device.

6. The method of claim 4, the signature file comprising a certificate generated by a manufacturer of the testing device to establish authenticity of the testing device.

7. The method of claim 4, the signature file comprising an identifier which links the results of the test of the characteristic and the user.

8. The method of claim 4, the signature file comprising an indication of the time at which the testing device was used to obtain the results of the test of the characteristic associated with the user.

9. The method of claim 4, wherein a cryptographic asymmetric keypair is used to generate the signature file, and the signature file is cryptographically signed by the testing device.

10. The method of claim 1, wherein testing the characteristic associated with the user comprises obtaining a biological sample from the user.

11. The method of claim 1, wherein testing the characteristic associated with the user further comprises performing operations to test the sample.

12. The method of claim 1, wherein testing the characteristic associated with the user is initiated by the user.

13. A testing device comprising:
a testing chip configured to test a characteristic associated with a user; and
a secure element configured to generate a signature file indicative of completion of the test of the characteristic associated with the user, wherein the signature file includes results of the test of the characteristic associated with the user and a certificate indicative that the results of the test of the characteristic associated with the user is certified.

14. The testing device of claim 13, the secure element comprising a secure cryptoprocessor to carry out cryptographic operations to certify the results of the test of the characteristic associated with the user.

15. The testing device of claim 13, the secure element comprising a hardware security module.

16. The testing device of claim 13, the secure element comprising a tamper-evident containment.

17. The testing device of claim 13, the testing device comprising at least one physical security measures to protect the secure element or the testing chip from tampering.

18. The testing device of claim 13, the secure element configured to monitor operations of the testing chip to verify the test of the characteristic associated with the user is performed correctly.

19. The testing device of claim 13, wherein the secure element uses a cryptographic asymmetric keypair to generate the signature file, and the signature file is cryptographically signed.

20. The testing device of claim 13, the signature file comprising one or more of:
a proof of execution that establishes that the testing chip executed correct executable code for the test of the characteristic associated with the user;
a public key associated with the testing device, wherein the public key is indicative of identity of the testing device;
a certificate generated by a manufacturer of the testing device to establish authenticity of the testing device;
an identifier which links the results of the test of the characteristic and the user; and
an indication of the time at which the testing device was used to obtain the results of the test of the characteristic associated with the user.
